(19) United States
(12) Patent Application Publication
(10) Pub. No.: US 2026/0148876 A1
(43) Pub. Date: May 28, 2026

(54) CONDUCTIVE PARTICLES, CONDUCTIVE MATERIALS USED THE SAME

(71) Applicant: DUK SAN NEOLUX CO., LTD., Cheonan-si (KR)

(72) Inventors: Chang Wan BAE, Cheonan-si (KR); Kyung Heum KIM, Cheonan-si (KR); Yeong Jin LIM, Cheonan-si (KR); Seok Won JEONG, Cheonan-si (KR); Hyunsang CHO, Cheonan-si (KR); Kyung Soo KIM, Cheonan-si (KR)

(73) Assignee: DUK SAN NEOLUX CO., LTD., Cheonan-si (KR)

(21) Appl. No.: 19/400,245

(22) Filed: Nov. 25, 2025

(30) Foreign Application Priority Data
Nov. 25, 2024 (KR) 10-2024-0169198
Oct. 1, 2025 (KR) 10-2025-0143305

(51) Int. Cl. H01B 1/08; H01R 4/58

(52) U.S. Cl. CPC H01B 1/08; H01R 4/58

(57) ABSTRACT

Provided are a conductive particle with low powder resistance and excellent stability comprising a core, a conductive layer formed on the core, and a metal oxide layer formed on the conductive layer; an anisotropic conductive material comprising the conductive particle; and a connection structure.

### TECHNICAL FIELD

The present disclosure relates to a conductive particle including a metal oxide layer on the surface of a conductive particle, an anisotropic conductive material, and a connection structure.

### BACKGROUND

A conductive particle is a material used in anisotropic conductive materials, such as Anisotropic Conductive Film (ACF), Anisotropic Conductive Paste (ACP), Anisotropic Conductive Ink (ACI), Anisotropic Conductive Sheet (ACS), and Anisotropic Conductive Adhesive (ACA). The anisotropic conductive material, in particular, ACF is used to make electrical connections between electrodes, which correspond to panel pixels, and driving ICs to implement images on a display panel.

Among the anisotropic conductive films (ACFs), when used for display applications, as display resolution increases, the electrode pitch decreases. Consequently, during the bonding of the upper and lower electrodes, some conductive particles may flow along with the ACF resin, and the flowed conductive particles can accumulate between the left and right electrodes, potentially causing a problem of a short circuit between them.

In order to solve these problems, a method of forming a surface treatment using an organic material on the surface of a conductive particle has been proposed. The surface treatment is generally performed by a method of physically and chemically attaching an organic material to the surface of a conductive particle. Although this method provides good initial characteristics, there is a problem in that the physically-attached surface treatment material may separate from the conductive particle over time, resulting in a deterioration of the surface treatment characteristics and an increase in powder resistance.

### SUMMARY

The present disclosure provides a conductive particle, which is constituted to include a core and a conductive layer formed on the core, wherein a metal oxide layer is thinly plated as a film on the surface of the conductive layer, thereby solving the problem of deterioration in surface treatment characteristics over time, and exhibiting low powder resistance and excellent surface treatment characteristics and reliability; an anisotropic conductive material including the conductive particle; and a connection structure.

The conductive particle of the present disclosure preferably includes a core; a conductive layer formed on the core; and a metal oxide layer on the conductive layer.

The metal of the metal oxide layer preferably contains Ni, Mn, Fe, Cu, Zn, Ag, Pd, Pt and Au, or a combination thereof.

The metal oxide layer preferably contains NiO, Ni₂O₃, MnO, Mn₂O₃, MnO₂, Mn₂O₇, FeO, Fe₂O₃, Fe₃O₄, Cu₂O, CuO, ZnO, Ag₂O, PdO, PtO₂, Au₂O₃, Ni(NO₃)₂, NiSO₄, Mn(NO₃)₂, MnSO₄, Fe(NO₃)₃, FeSO₄, Fe₂(SO₄)₃, Cu(NO₃)₂, CuSO₄, Zn(NO₃)₂, ZnSO₄, AgNO₃, Pd(NO₃)₂, PdSO₄, and Pt(SO₄)₂, or a combination thereof; more preferably Ni(NO₃)₂, Mn(NO₃)₂, FeSO₄, Cu(NO₃)₂, ZnSO₄, Ag₂O, PtO₂, PdO, NiSO₄, FeO, Pd(NO₃)₂, AgNO₃, Zn(NO₃)₂, Fe(NO₃)₃, and Fe₂(SO₄)₃, or a combination thereof.

The metal oxide layer has a thickness of 0.1 nm to 100 nm, preferably 5 nm to 90 nm, 10 nm to 80 nm, or 20 nm to 70 nm, and most preferably 30 nm to 70 nm.

The conductive particle preferably has a powder resistance increase rate of 300% or less after surface treatment.

The core preferably includes resin particles or organic/inorganic hybrid particles.

The conductive layer preferably includes Ni, and includes one or more selected from the group consisting of P, B, Cu, Au, Ag, W, Mo, Pd, Co, and Pt.

In another aspect of the present disclosure, it is preferable to provide an anisotropic conductive material including a conductive particle.

In still another aspect of the present disclosure, it is preferable to provide a connection structure including the anisotropic conductive material.

### Advantageous Effects

The present disclosure provides a conductive particle having excellent surface treatment characteristics and reliability by applying a metal oxide layer to the conductive layer surface of a conductive particle, an anisotropic conductive material including the conductive particle, and a connection structure.

### DETAILED DESCRIPTION

Hereinafter, exemplary embodiments of the present disclosure are described in detail with reference to accompanying drawings. When reference numerals are assigned to components in the drawings, identical components are denoted by the same numerals as much as possible, even if when illustrated in different drawings.

When describing the present disclosure, if a detailed description of a related known configuration or function is determined to obscure the gist of the present disclosure, such detailed description may be omitted. When the terms “include”, “have”, or “consist of” are used in this specification, other components may be added unless “only” is used. When a component is expressed in the singular form, it may also encompass cases the plural form unless otherwise explicitly stated.

In describing the components of the present disclosure, terms such as first, second, A, B, (a), (b), etc. may be used. Such terms are merely used to distinguish one component from another, and do not limit the essence, order, sequence, or number of the components by such terms.

In describing the positional relationship between components, when it is stated that two or more components are “linked”, “coupled”, or “connected”, it should be understood that the components may be directly “linked” “coupled,” or “connected” to each other, but may also be “linked”, “coupled”, or “connected” with one or more other components interposed therebetween. In particular, the other component may be included in at least one of the two or more components that are “linked”, “coupled”, or “connected” to each other.

In addition, when a layer, film, region, plate, etc. is described as being “on” or “over” another component, it should be understood that this includes not only cases where it is disposed “directly on” the other component, but also cases where another component is interposed therebetween. In contrast, when a component is described as being “directly on” another component, it should be understood that there is no other component interposed therebetween.

In describing the temporal flow relationship among components, operating steps, or manufacturing processes, when expressions such as “after”, “following”, “subsequent to”, or “before” are used to describe the order or sequence in time or process flow, it can also include cases where it is not continuous, unless “immediately” or “directly” is used.

Meanwhile, when numerical values or corresponding information for components are mentioned, even without separate explicit description, the numerical values or corresponding information may be interpreted as including an error range that may occur due to various factors (e.g., process factors, internal or external impact, noise, etc.).

The terms used in this specification and the accompanying claims have the following meanings, unless otherwise stated, without departing from the spirit of the present disclosure.

Hereinafter, implementation examples of the present disclosure will be described in detail. However, these are provided as examples and The Present Disclosure is not limited thereby, and the present disclosure is defined only by the scope of the claims described below. Each component is described in detail below.

### 1. Conductive Particle

The conductive particle according to an example of the present disclosure includes a core; a conductive layer provided on the core; and a metal oxide layer provided on the conductive layer.

The core is an insulating bead having very low electrical conductivity, which may be prepared by resin particles or organic/inorganic hybrid particles. The core is used in an anisotropic conductive material so that a conductive particle is prepared from a material that does not break when electrically connected. That is, when the conductive particle according to the examples of the present disclosure is subjected to a force within the range for electrical connection between electrodes, the insulating bead inside the conductive particle is very easily deformed but does not break.

As the resin particle, a copolymer may be used that is obtained by polymerizing at least one monomer selected from the group consisting of urethane-based, acrylate-based, benzene-based, epoxy-based, and amine-based monomers, or a mixture of two or more of the foregoing monomers, by a method such as seed polymerization, dispersion polymerization, suspension polymerization, or emulsion polymerization.

As the acrylate-based monomer, one or more selected from the group consisting of methyl methacrylate (MMA), ethyl methacrylate, propyl methacrylate, butyl methacrylate, benzyl methacrylate, methyl acrylate (MA), ethyl acrylate (EA), propyl acrylate, butyl acrylate, 2-ethylhexyl acrylate, 1,6-hexanediol diacrylate, tetramethylol methane tetraacrylate, polyethylene glycol diacrylate, polyethylene glycol dimethacylate, polypropylene glycol diacrylate, and polyethylene glycol dimethacylate may be used.

The benzene-based monomer includes a divinyl benzene monomer and a styrene-based monomer.

As the styrene-based monomer, one or more selected from the group consisting of styrene, α-methylstyrene, β-methylstyrene, p-methylstyrene, ethylstyrene, hydroxystyrene, vinylxylene, monochlorostyrene, dichlorostyrene, dibromostyrene, and vinylnaphthalene may be used.

The amine-based monomer includes an amide-based monomer and an imide-based monomer.

As the amide-based monomer, one or more selected from the group consisting of acrylamide, N-isopropylacrylamide, methacrylamide, hexamethylenediamine, adipic acid, caprolactam, laurolactam, N,N-dimethylacrylamide, N,N′-methylenebisacrylamide, terephthaloyl chloride, and p-phenylenediamine may be used.

As the imide-based monomer, one or more selected from the group consisting of pyromellitimide, naphthalimide, pyridinedimide, imidazole imide, tetracarboxyimide, benzoimide, phenylimide, diethyl imide, isophthalimide, and imidazophenone imide may be used.

The organic/inorganic hybrid particle preferably has an insulating bead (core)-shell structure. When the insulating bead is an organic material, the shell is an inorganic material, whereas when the insulating bead is an inorganic material, the shell is an organic material. The reason for forming a shell is selected in consideration of the characteristics of the resin used in the anisotropic material.

When the insulating beads are made of organic/inorganic hybrid particles, the organic/inorganic hybrid particles preferably have a core-shell structure, in which when the core is organic, the shell is an inorganic material, whereas when the core is an inorganic material, the shell is an organic material.

In particular, the organic material may be a polymer, in which monomers used in the aforementioned resin particles are used, and as the inorganic material, oxides (SiO₂, TiO₂, Al₂O₃, ZrO₂, etc.); nitrides (AlN, Si₃N₄, TiN, BaN, etc.); and carbides (WC, TiC, SiC, etc.) may be used.

Methods for forming a shell include a chemical coating method, a sol-gel method, a spray coating method, a chemical vapor deposition (CVD) method, a physical vapor deposition (PVD) method, a plating method, etc.

In addition, the conductive layer of the present disclosure is a layer for imparting conductivity to a conductive particle, by including Ni, may consist of one or more selected from the group consisting of P, B, Cu, Au, Ag, W, Mo, Pd, Co, and Pt.

Specifically, the conductive layer may, by including Ni, may consist of an alloy component composed of two elements such as Ni—P, Ni—B, Ni—W, Ni—Mo, and Ni—Co, or three elements such as Ni—P—Pd, Ni—B—Pd, Ni—P—Co, Ni—B—Co, Ni—P—W, and Ni—B—W, or four or more elements, but is not limited thereto.

The conductive layer including Ni preferably has a thickness of 80 nm to 400 nm, more preferably 90 nm to 300 nm, and most preferably 100 nm to 250 nm.

When the thickness of the conductive layer is less than the above-identified range, the electrical resistance of the conductive particle increases, whereas when it exceeds the above-identified range, peeling of the conductive layer and the insulating bead(s) may occur even when a conductive particle is slightly deformed under the heating/pressure bonding conditions of an anisotropic conductive material, which may reduce the reliability of the product.

The conductive layer may consist of a multilayer which includes a first layer including Ni; and a second layer including one or more elements selected from Au, Ag, Pt, and Pd in the first layer. The metal layer of the second layer serves to increase the electrical conductivity of a conductive particle and prevent oxidation of the conductive layer.

In addition, the method for forming the precious metal layer may employ a conventionally known technique such as sputtering, plating, or deposition, but is not limited thereto.

Additionally, the conductive layer may include a protrusion.

The shape of the above protrusion may be spherical, elongated, or a cluster of multiple particles, but is not limited thereto. The most preferred shape is one that tapers toward the ends.

The method for forming the protrusions is not particularly limited. The protrusions may be formed by a method in which they are grown integrally with the conductive layer, by attaching nano-sized particles to the core and then forming the conductive layer, or by forming a first conductive layer on the core, attaching nano-sized particles thereto, and then forming a second conductive layer made of the same or different material as the first conductive layer.

The size of the protrusions is preferably 50 nm to 500 nm, and preferably 100 nm to 350 nm.

Insulating particles are particles which are formed in a first region on a conductive layer to prevent short circuits with adjacent electrodes when a conductive particle is used as an anisotropic conductive material, and when protrusions are provided, the insulating particles may also be provided on the protrusions.

As the material for insulating particles, insulating resin particles or inorganic particles may be used. The resin particles include one or more resins selected from the group consisting of styrene or a styrene-based material containing an alkyl group having one or more carbon atoms, and an acrylate-based material including an acrylate or methacrylate material containing an alkyl group having one or more carbon atoms, and a diacrylate or dimethacrylate at both ends of a glycol having one or more carbon atoms; and the inorganic particles include one or more materials selected from the group consisting of a trimethoxysilane-based material containing an acrylic group, a phenyl group, and a vinyl group.

The particle size may be 90 nm or larger to exhibit an insulating effect, but is preferably 100 nm to 300 nm, and more preferably 100 nm to 250 nm, to secure connection resistance and insulation resistance.

Additionally, to improve insulation and electrical conductivity, insulating particles of different particle sizes may be mixed and used, and organic/inorganic particles may also be mixed and used.

As a method for attaching insulating particles to the surface of a conductive particle, a method (wet method) is used, in which a solvent, a conductive particle, and an insulating particle are mixed together and attached, and the insulating particle, which is a polymer having, on its surface, a first substituent that has a bonding force with the metal of the conductive layer of a conductive particle, and is attached to the conductive layer or the protrusion of the insulating particle by means of the first substituent.

The first substituent may be any heteroatom or substituent that forms a covalent bond, polar bond, or other bonding interaction with a metal or has a high affinity for the metal and can be attached and fixed to the metal surface. Specifically, the first substituent may be selected from the group consisting of a hetero group, an ether group, a carbonic acid group, and a hydroxyl group, and at least one hetero group selected from the group consisting of sulfur, phosphorus, nitrogen, and oxygen may preferably be used.

In particular, it is preferable that the insulating particles be attached to 5% to 40% of the total surface area of the conductive layer (including protrusions, if any). When the proportion is less than 5%, the insulating particle ratio is low, making it difficult to exhibit an insulating effect, whereas when it exceeds 40%, there is a problem in tht connection resistance increases as the number of insulating particles increases. Therefore, even when insulating particles are attached, a portion of the conductive layer surface of a conductive particle remains exposed.

### 2. Metal Oxide Layer

The metal oxide layer according to an example of the present disclosure is formed on the conductive layer as a layer that prevents bonding between insulating particles, and is formed in a second region on the conductive layer other than the first region formed on the conductive layer.

That is, it is preferable that the metal oxide layer consist of a material that is reactive with the metal of the conductive layer but not reactive with the insulating particles.

It is preferable that the material constituting the metal oxide layer is a metal oxide.

The metal oxide layer consisting of the metal oxide of the present disclosure may be firmly bonded to the conductive layer composed of a metal, and has excellent surface treatment characteristics and may reduce the powder resistance value, thereby increasing the reliability of conductive particles.

The metal of the metal oxide preferably includes Ni, Mn, Fe, Cu, Zn, Ag, Pd, Pt, and Au, or a combination thereof, and more preferably includes Ni, Cu, Mn, Pd, and Pt, or a combination thereof.

The metal oxide preferably includes NiO, NI₂O₃, MnO, Mn₂O₃, MnO₂, Mn₂O₇, FeO, Fe₂O₃, Fe₃O₄, Cu₂O, CuO, ZnO, Ag₂O, PdO, PtO₂, Au₂O₃, Ni(NO₃)₂, NiSO₄, Mn(NO₃)₂, MnSO₄, Fe(NO₃)₃, FeSO₄, Fe₂(SO₄)₃, Cu(NO₃)₂, CuSO₄, Zn(NO₃)₂, ZnSO₄, AgNO₃, Pd(NO₃)₂, PdSO₄, and Pt(SO₄)₂, or a combination thereof, and more preferably includes Ni(NO₃)₂, Mn(NO₃)₂, FeSO₄, Cu(NO₃)₂, ZnSO₄, Ag₂O, PtO₂, PdO, NiSO₄, FeO, Pd(NO₃)₂, AgNO₃, Zn(NO₃)₂, Fe(NO₃)₃, and Fe₂(SO₄)₃, or a combination thereof.

The metal oxide layer has a thickness of 0.1 nm to 100 nm, preferably 5 nm to 90 nm, 10 nm to 80 nm, or 20 nm to 70 nm, and most preferably 30 nm to 70 nm.

The reason why the metal oxide layer thickness is preferable within an appropriate range is that, when it is too thin, it cannot sufficiently function as a protective layer, resulting in poor durability and stability, whereas when it is too thick, the electrical resistance increases significantly, thereby reducing conductivity. Within the appropriate thickness range, the metal oxide layer effectively protects the particle without significantly impeding current flow, thereby maintaining a balance between electrical performance and physical stability. In particular, within the most desirable thickness range, the oxide layer provides sufficient protection while minimizing unnecessary increases in resistance, thereby optimizing the reliability and lifespan of a conductive particle. Therefore, limiting the metal oxide layer thickness within an appropriate range is crucial for ensuring product performance and durability.

The conductive particle of the present disclosure preferably has a powder resistance increase rate of 300% or less after surface treatment of the metal oxide layer, preferably 280% or less, 260% or less, 240% or less, or 220% or less, and most preferably 200% or less.

When the powder resistance increase rate after formation of the metal oxide layer is within the above-mentioned range, the electrical properties of a conductive particle are maintained, thereby ensuring smooth current flow, while the metal oxide layer enhances the particle's durability and stability. In contrast, when the increase rate is excessively high, current flow is impeded, degrading electrical performance, and as the oxide layer thickens, physical damage to the particle and a shortened lifespan may occur. Therefore, maintaining the resistance increase rate within an appropriate range is crucial for improving electrical performance and material reliability.

A conductive particle of the present disclosure preferably has a resistance increase of 300% or less, preferably 280% or less, 260% or less, 240% or less, or 220% or less, and most preferably 200% or less, after an 85/85 reliability evaluation, relative to the initial resistance.

The reason why it is preferable for the resistance increase rate after the 85/85 reliability evaluation to be within a certain range relative to the initial resistance is that the electrical properties of a conductive particle can be stably maintained, thereby allowing for smooth current flow, and the metal oxide layer can faithfully perform the particle's durability and protective function. The lower the resistance increase rate, the less the electrical performance degrades, thereby further improving the reliability and lifespan of the material. In contrast, when the resistance increase rate is excessively high, electrical conduction becomes difficult, significantly reducing electrical performance, and as the oxide layer becomes thicker, physical damage to the particle, delamination, and cracking may occur, thereby shortening the material lifespan and increasing the defect rate in the manufacturing process. Therefore, controlling the resistance increase rate below an appropriate level is crucial for ensuring the electrical efficiency and durability of the product.

It is preferable that the 85/85 reliability evaluation be performed for 72 hours under environmental conditions of 85° C. and 85% RH humidity.

### 3. Method for Preparing Conductive Particle and Metal Oxide Layer

A method for preparing a conductive particle according to an example of the present disclosure includes a step of providing a core (S1), a step of forming a conductive layer (S2), optionally a step of attaching insulating particles (S3), a step of surface treatment (S4), and a step of drying (S5).

In particular, the step of providing a core (S1) includes a step of synthesizing core particles (S1a) and a steo of activating a plating catalyst (S1b).

First, the step of synthesizing core particles (S1a) is a step of preparing a core by polymerizing a copolymer using a monomer such as a urethane-based, styrene-based, acrylate-based, benzene-based, epoxy-based, amine-based, or imide-based monomer, or a modified monomer thereof, or a mixed monomer of the foregoing monomers, by a method such as seed polymerization, dispersion polymerization, suspension polymerization, or emulsion polymerization.

When the core is a hybrid particle, the core has a core-shell structure, if the core is organic, the shell is inorganic, whereas when the core is inorganic, the shell is organic. As the organic material to be used here, the above-mentioned monomer, modified monomer, or mixed monomer may be used, and in particular, the inorganic material to be used here may be an oxide including SiO₂, TiO—, Al₂O₃, and ZrO₂, a nitride including AlN, Si₃N₄, TiN, and BaN, a carbide including WC, TiC, and SiC; etc.

As a method for forming the shell, chemical coating, sol-gel, spray coating, chemical vapor deposition (CVD), physical vapor deposition (PVD), plating, etc. may be used.

Additionally, a form in which inorganic particles are dispersed within an organic matrix, a form in which organic particles are dispersed within an inorganic matrix, and a form in which organic/inorganic materials are dispersed in a 50:50 ratio are also possible.

For example, an ethoxylate triacrylate monomer and an ethoxylate diacrylate monomer are used as the organic material, and a solution where a solvent and a polymerization initiator are mixed is subjected to dispersion treatment. In particular, the dispersion treatment may include homogenization treatment using ultrasonic waves.

In addition, a solution containing a dispersion stabilizer and a surfactant is added to the solution for dispersion treatment, and a polymerization process is performed under elevated temperature conditions to form a core.

Then, in the step of activating a plating catalyst (S1b), the core particles prepared in the previous step S1a are activated with an electroless plating catalyst. In particular, the plating catalyst used in the step of activating a plating catalyst (S1b) may be replaced with attaching a small metal or inorganic particles to insulating particles, as long as this can provide the same effect.

Specifically, in the step of activating a plating catalyst (S1b), core particles are treated with a surfactant and then pretreated using various methods known for sensitizing an electroless plating catalyst, and then the sensitized core particles are placed into a solution containing a precursor of the electroless metal plating catalyst and then subjected to activation treatment.

The core particles activated in this manner are placed in a solution containing a strong acid and stirred at room temperature to perform acceleration treatment, thereby obtaining catalyst-treated core particles for electroless plating.

Then, the step of forming a conductive layer with protrusions (S2) includes a core dispersion step (S2a) and a step of forming a conductive layer (S2b).

The core dispersion step (S2a) involves dispersing the core in an alloy plating solution that will form the conductive layer. The alloy plating solution is prepared by sequentially dissolving a precursor of an alloy element, a complexing agent, lactic acid, a stabilizer, and a surfactant.

The catalyst-treated core particles obtained in the step (S1b) are added to the prepared plating solution, and dispersion treatment is performed using an ultrasonic homogenizer.

It is preferable to adjust the pH of the dispersion treatment solution to pH 5.5 to 6.5 using ammonia water, etc., because this improves the adhesion and dispersibility of the insulating particles and the conductive layer in the initial Ni reduction reaction in the step of forming a conductive layer (S2b) described later. When the pH is below 5.5, for example, pH 4 or lower, the adhesion and dispersibility are good, but the reactivity is too low; therefore, there is a possibility that some particles may not be plated. In addition, when the pH is high exceeding 6.5, the conductive layer surface may be formed sparsely due to abnormal precipitation of Ni, resulting in poor adhesion and dispersibility.

Subsequently, a treatment (S2b), in which a conductive layer is formed on the core immersed in the dispersion-treated plating solution, is performed. The number of layers, materials, and the method of forming the conductive layer or the method of forming protrusions are not limited. The thickness of the conductive layer is formed to be 80 nm to 400 nm, and the protrusions may be formed integrally or separately. For example, the protrusions may be grown integrally with the conductive layer, or the conductive layer may be formed after nano-sized particles are attached to the core, or the first conductive layer may be formed on the core, nano-sized particles may be attached thereto, and a second conductive layer made of the same or different material as the first conductive layer may be formed to form the protrusions.

As the formation of protrusions integrally with the conductive layer, for example, in the core dispersion step (S2a), one or more precursors selected from P and B are added to the nickel-based alloy plating solution, and in the step of forming a conductive layer with protrusions (S2b), alloy elements including one or more precursors selected from Cu, Au, Ag, W, Mo, Pd, Co, and Pt are dividedly added to the dispersion-treated plating solution to form a conductive layer with protrusions through a concentration gradient.

In particular, the alloy elements that are dividedly added may be added in 2 to 5 divided portions at intervals of 10 to 30 minutes, or in 2 to 4 divided portions at intervals of 15 to 25 minutes. In particular, the addition amount may be added in divided portions with increased content, or may be added continuously as needed; however, it is preferable to increase the amount added at certain time intervals according to the addition rate because this can increase the concentration in the direction of the protrusions.

Before and after the above-described divided addition, it is preferable to maintain the pH of the plating solution within a controlled range according to the type of the alloy elements added to form a conductive layer with protrusions. For example, in a case where a precursor of P is added, it is preferable to maintain the pH to be within a range of 5.5 to 6.0, whereas in a case where a precursor of B is added, it is desirable to maintain the pH within a range of 8.5 to 9.0. In particular, when the pH of the plating solution is low, the reactivity is low, thereby causing a problem in forming protrusions, whereas when the pH is too high, excessive abnormal precipitation occurs, thereby breaking the balance of the plating solution and resulting in defective plating.

In addition, it is more preferable to provide a temperature rise condition so that the desired protrusion can be formed without excessive abnormal precipitation among the protrusion-forming mechanisms.

The step of attaching insulating particles (S3) is a step for selectively attaching insulating particles to the conductive layer. There are dry and wet methods for attaching insulating particles to the surface of a conductive particle; however, the wet method is preferred in this example. This is because the dry method involves particles colliding with one another at high temperatures, which makes it difficult to achieve uniform particle attachment.

The wet method is a method in which a solvent, conductive particles, and insulating particles are mixed and attached together, and the insulating particles are attached to the conductive layer or protrusions by providing a substituent that is reactive with the metal of the conductive layer of the conductive particle on the surface of the insulating particles. That is, the surface of the insulating particle has a substituent that improves the reactivity with the metal of the conductive layer of the conductive particle or the surface of the protrusion. As the substituent, one selected from the group consisting of a hetero group, a thiol group, a carbonic acid group, and a hydroxyl group may be used. At least one selected from the group consisting of sulfur, phosphorus, nitrogen, and oxygen may preferably be used as the hetero group.

Meanwhile, in addition to having a substituent on the surface of an insulating particle, a substituent may also be provided on the surface of a conductive particle. In this case, it is preferable that the substituent on the insulating particle and the substituent on the conductive particle have a high bonding strength with each other.

In the wet method, insulating particles are not formed on the entire surface of a conductive particle, but are formed on 5% to 40% of the total area of the outer surface of the conductive layer (including protrusions, if any). This is because the insulating particles have a surface that has an affinity for the surface of a conductive particle, and thus, the insulating particles have a low tendency to adhere to each other. Therefore, some of the surfaces of a conductive particle are open, exposing the conductive layer.

Meanwhile, in order to improve the insulation and electrical conductivity effects, insulating particles of different particle sizes may be mixed and used, and it is also possible to use a mixture of organic/inorganic particles

In order to better attach insulating particles to the surface of a conductive particle, the adhesive strength of the insulating particle and the area to which the insulating particle attaches to the conductive particle may be controlled by providing a substituent not only on the surface of the insulating particle but also on the surface of the conductive particle.

The surface treatment step (S4) is a step of introducing a metal oxide layer to the surface of a conductive particle.

The surface treatment step is preferably performed by adding a metal oxide or a hydrate of a metal oxide, a conductive particle surface modifier (stearic acid, etc.), distilled water (DI water), and ethanol and stirring; adding a conductive particle to the solution and heating the mixture at a high temperature.

The metal oxide layer consisting of the metal oxide of the present disclosure may be firmly bonded to the conductive layer consisting of a metal, and has excellent surface treatment characteristics and may reduce the powder resistance value, thereby increasing the reliability and stability of a conductive particle.

The metal of the metal oxide preferably includes Ni, Mn, Fe, Cu, Zn, Ag, Pd, Pt, and Au, or a combination thereof, and more preferably includes Ni, Cu, Mn, Pd, and Pt, or a combination thereof.

The metal oxide preferably includes NiO, NI₂O₃, MnO, Mn₂O₃, MnO₂, Mn₂O₇, FeO, Fe₂O₃, Fe₃O₄, Cu₂O, CuO, ZnO, Ag₂O, PdO, PtO₂, Au₂O₃, Ni(NO₃)₂, NiSO₄, Mn(NO₃)₂, MnSO₄, Fe(NO₃)₃, FeSO₄, Fe₂(SO₄)₃, Cu(NO₃)₂, CuSO₄, Zn(NO₃)₂, ZnSO₄, AgNO₃, Pd(NO₃)₂, PdSO₄, and Pt(SO₄)₂, or a combination thereof, and more preferably includes Ni(NO₃)₂, Mn(NO₃)₂, Fe₂SO₄, Cu(NO₃)₂, ZnSO₄, Ag₂O, PtO₂, PdO, NiSO₄, FeO, Pd(NO₃)₂, AgNO₃, Zn(NO₃)₂, Fe(NO₃)₃, and Fe₂(SO₄)₃, or a combination thereof.

The metal oxide layer has a thickness of 0.1 nm to 100 nm, preferably 5 nm to 90 nm, 10 nm to 80 nm, or 20 nm to 70 nm, and most preferably 30 nm to 70 nm.

The drying step (S5) is a step for drying a conductive particle prepared by a wet method, in which the drying process is performed at a temperature between 100° C. and 200° C., although the drying temperature may vary depending on the type of solvent.

When the insulating particles are attached to the conductive particle by a wet method, since the conductive particle is in a solution state with the solvent, the drying step is a step for drying the solvent in order to obtain a desired density and connection resistance of the conductive particle by adding an accurate amount in preparing an anisotropic conductive material.

In the drying step of the present disclosure, as described above, a metal oxide layer is formed, and due to the substituents of the selectively attached insulating particles, a phenomenon occurs in which the insulating particles attached to the surface of a conductive particle and the surface of a conductive particle (conductive layer) to which the insulating particles are not attached are attached to each other during the drying process, and as time passes after drying, but a phenomenon in which adjacent conductive particles and insulating particles are naturally attached occurs, so that the problem of multiple particles clumping together during the final ACF preparation does not occur.

In addition, since a conductive particle has a hydrophobic property and a metal oxide layer having a substituent capable of bonding with a metal is formed on the outer surface of the conductive layer, the insulating particle is prevented from adhering to the conductive layer of another conductive particle, and the metal oxide layer is not formed on the outer surface of the insulating particle; therefore, when a metal oxide layer is formed over the entire outer surface of a conductive particle, the surface treatment materials are prevented from reacting with each other and the occurrence of coagulated conductive particles having attached insulating particles can be reduced.

### 4. Anisotropic Conductive Material

The present disclosure provides an anisotropic conductive material by dispersing conductive particles in a resin binder. Examples of the anisotropic conductive material include an anisotropic conductive paste, an anisotropic conductive film, an anisotropic conductive sheet, etc. After uniformly dispersing conductive particles in a resin binder, they may be used as an anisotropic conductive paste, or they may be thinly spread on the surface of a release paper to be used as an anisotropic film.

In particular, the resin binder is not particularly limited. For example, vinyl resins such as styrene-based, acryl-based, and vinyl acetate-based resins; thermoplastic resins such as polyolefin-based and polyamide-based resins; and curable resins such as urethane-based and epoxy-based resins. These resins may be used alone or in combination. In particular, it is preferable for the resin binder to contain a monomer of the same series as the aforementioned core, because this will allow for similar behavior under varying temperature environments.

For the purpose of polymerization or curing of the binder resin, a radical initiator such as benzoyl peroxide (BPO), a photoinitiator such as trimethylbenzoyl phenylphosphinate (TPO), or an epoxy-based latent curing agent such as HX3941HP may be used alone or in combination.

Additionally, other materials may be added to the resin binder as long as they do not hinder the achievement of the purpose of the present disclosure. For example, colorants, softeners, heat stabilizers, light stabilizers, antioxidants, inorganic particles, etc. may be used.

### 5. Connection Structure

When a conductive particle is used as described above in the present disclosure, the purpose, structure, and material of a connection structure are not particularly limited. That is, a connection structure is a method of connecting circuit boards using a conductive particle of the present disclosure or an anisotropic conductive material of the present disclosure. For example, a method of electrically connecting a display driver IC and an FPC is used. The connection structure of the present disclosure prevents short circuiting between the left and right electrodes during bonding, thereby preventing circuit malfunction.

Hereinafter, the Synthesis Examples and Examples according to the present disclosure are described in detail, but the synthesis examples and examples of The present disclosure are not limited thereto.

### EXAMPLES

### I. Preparation of Conductive Particles

### 1) Synthesis of Insulating Core Particles

In a 3 L glass beaker, 1100 g of monomer tetramethylol methane tetraacrylate (TMMT), 400 g of divinylbenzene, 15 g of 1,6-hexanediol diacrylate, and 30 g of styrene were added, and then 5 g of initiator BPO was added. The mixture was treated in a 40 kHz ultrasonic bath for 10 minutes to prepare a first solution. In a 5 L PP beaker, 3,000 g of deionized water, 500 g of dispersion stabilizer Polyvinylpyrrolidone (PVP)-30K, and 200 g of surfactant Solusol (dioctyl sulfosuccinate sodium salt) were added and dissolved to prepare a second solution.

The first solution and the second solution were placed in a 50 L reactor, and 40,000 g of deionized water was added thereto, and the mixture was treated with an ultrasonic homogenizer (20 kHz, 600 W) for 90 minutes, and the temperature was raised to 35° C. while rotating the solution at 120 rpm, and maintained for 3 hours. The temperature was then raised again to 85° C., and after the solution reached 85° C., it was maintained for 16 hours to perform a polymerization process. The polymerized fine particles were filtered, washed, classified, and dried to obtain core resin particles. The average diameter of the prepared core resin particles was measured using a mode value using a Particle Size Analyzer (BECKMAN MULTISIZER TM3). The number of core particles measured at this time was 75,000. The average diameter was 3.51 μm.

### 2) Formation of Outer Conductive Layer on Insulating Core Particle

### (1) Catalytic Treatment Process

30 g of the prepared insulating core particles were placed in a solution of 800 g of deionized water, 0.5 g of surfactant Triton X100, and 10 g of sulfuric acid, and treated in an ultrasonic bath for one hour to perform a washing and degreasing process to remove excess unreacted monomers and oil components present in the insulating core particles. The final step of the washing and degreasing process was a three-time washing process using 45° C. deionized water.

The insulating core particles that had completed the degreasing and washing processes were placed in a solution containing 150 g of stannous chloride and 300 g of 35-37% hydrochloric acid dissolved in 600 g of deionized water, and sensitized by immersion and stirring for 30 minutes at 30° C., and then washed three times.

The sensitized insulating core was placed in 1 g of palladium chloride, 200 g of 35-37% hydrochloric acid, and 600 g of deionized water, and activated at 40° C. for one hour. During the activation process, ultrasonic waves were applied using an ultrasonic bath. After the activation process, the water rinsing process was performed three times.

The activated insulating core was placed in a solution of 100 g of 35-37% wt % aqueous hydrochloric acid solution and 600 g of deionized water, and stirred at room temperature for 10 minutes to perform acceleration treatment. After the acceleration treatment, the core was washed three times to obtain a catalyst-treated insulating core for electroless plating.

### (2) Plating Process

In a 5 L reactor, 70 g of nickel sulfate as a Ni salt, 5 g of sodium acetate as a complexing agent, 2 g of lactic acid, 0.001 g of Pb-acetate as a stabilizer, 0.001 g of sodium thiosulfate, and 1 g of PEG-600 as a surfactant were sequentially dissolved in 3,500 g of deionized water to prepare solution (a). The catalyst-treated insulating core was added to the prepared solution (a) and dispersed for 10 minutes using an ultrasonic homogenizer. After the dispersion, the pH of the solution was adjusted to 8.0 using ammonia water-Solution (b). Solution (c) was prepared by dissolving 300 g of deionized water, 33 g of DMAB as a reducing agent, and 0.002 g of sodium thiosulfate as a stabilizer in a 1 L beaker. Solution (d) was prepared by dissolving 500 g of deionized water, 155 g of nickel sulfate, and 10 g of sodium hydroxide in a 1 L beaker.

While maintaining the temperature of the 5L reactor solution (b) at 20° C., solution (c) was added at a rate of 5 g per minute using a quantitative pump, and the reactor temperature was heated and maintained at 35° C. at a heating rate of 0.33° C. To adjust the pH of the 5L reactor solution (b) to 8.0 until the solution temperature reached 35° C., additional ammonia water was added, and no ammonia water was added after 75° C.

After the solution (c) was added, 5 minutes later, the solution (d) was added to the 5L reactor at a rate of 20 g per minute using a quantitative pump. After the addition of the solution (c), the solution was maintained for 30 minutes to obtain a conductive particle plated with Ni.II.

### Surface Treatment of Conductive Particle

### (Example 1) Surface Treatment of Ni(NO₃)₂

Add 20 g of stearic acid and 50 g of DI water to 20 g of Ni(NO₃)₂·6H₂O, and stir the mixture for 30 minutes while adding 50 mL of ethanol. Then, add 20 g of the conductive particles prepared in the process I to the solution, and seal the mixture and heat in an autoclave at 120° C. for 30 minutes, cool to room temperature, and then wash the surface-treated conductive particles with DI water and dry in a conventional oven for 12 hours.

### (Example 2) Surface Treatment of Ni(NO₃)₂

Ni(NO₃)₂ is subjected to surface treatment in the same manner as in Example 1, except that Ni(NO₃)₂ is sealed in an autoclave and heated for 45 minutes.

### (Example 3) Surface Treatment of Ni(NO₃)₂

Ni(NO₃)₂ is subjected to surface treatment in the same manner as in Example 1, except that Ni(NO₃)₂ is sealed in an autoclave and heated for 1 hour.

### (Example 4) Surface Treatment of Ni(NO₃)₂

Ni(NO₃)₂ is subjected to surface treatment in the same manner as in Example 1, except that Ni(NO₃)₂ is sealed in an autoclave and heated for 3 hours.

### (Example 5) Surface Treatment of Ni(NO₃)₂

Ni(NO₃)₂ is subjected to surface treatment in the same manner as in Example 1, except that Ni(NO₃)₂ is sealed in an autoclave and heated for 6 hours.

### (Example 6) Surface Treatment of Mn(NO₃)₂

Add 20 g of stearic acid and 50 g of DI water to 20 g of Mn(NO₃)₂·4H₂O, and stir the mixture for 30 minutes while adding 50 mL of ethanol. Then, add 20 g of the conductive particles prepared in the process I to the solution, and seal the mixture and heat in an autoclave at 120° C. for for 1 hour, cool to room temperature, and then wash the surface-treated conductive particles with DI water and dry in a conventional oven for 12 hours.

### (Example 7) Surface Treatment of FeSO₄

Add 20 g of stearic acid and 50 g of DI water to 20 g of FeSO₄·7H₂O, and stir the mixture for 30 minutes while adding 50 mL of ethanol. Then, add 20 g of the conductive particles prepared in the process I to the solution, and seal the mixture and heat in an autoclave at 120° C. for 1 hour, cool to room temperature, and then wash the surface-treated conductive particles with DI water and dry in a conventional oven for 12 hours.

### (Example 8) Surface Treatment of Cu(NO₃)₂

Add 20 g of stearic acid and 50 g of DI water to 20 g of Cu(NO₃)₂·3H₂O, and stir the mixture for 30 minutes while adding 50 mL of ethanol. Then, add 20 g of the conductive particles prepared in the process I to the solution, and seal the mixture and heat in an autoclave at 120° C. for 1 hour, cool to room temperature, and then wash the surface-treated conductive particles with DI water and dry in a conventional oven for 12 hours.

### (Example 9) Surface Treatment of ZnSO₄

Add 20 g of stearic acid and 50 g of DI water to 20 g of ZnSO₄·7H₂O, and stir the mixture for 30 minutes while adding 50 mL of ethanol. Then, add 20 g of the conductive particles prepared in the process I to the solution, and seal the mixture and heat in an autoclave at 120° C. for 1 hour, cool to room temperature, and then wash the surface-treated conductive particles with DI water and dry in a conventional oven for 12 hours.

### (Example 10) Surface Treatment of Ag₂O

Add 20 g of stearic acid and 50 g of DI water to 20 g of Ag₂O, and stir the mixture for 30 minutes while adding 50 mL of ethanol. Then, add 20 g of the conductive particles prepared in the process I to the solution, and seal the mixture and heat in an autoclave at 120° C. for 1 hour, cool to room temperature, and then wash the surface-treated conductive particles with DI water and dry in a conventional oven for 12 hours.

### (Example 11) Surface Treatment of PtO₂

Add 20 g of stearic acid and 50 g of DI water to 20 g of PtO₂, and stir the mixture for 30 minutes while adding 50 mL of ethanol. Then, add 20 g of the conductive particles prepared in the process I to the solution, and seal the mixture and heat in an autoclave at 120° C. for 30 minutes, cool to room temperature, and then wash the surface-treated conductive particles with DI water and dry in a conventional oven for 12 hours.

### (Example 12) Surface Treatment of PdO

Add 20 g of stearic acid and 50 g of DI water to 20 g of PdO, and stir the mixture for 30 minutes while adding 50 mL of ethanol. Then, add 20 g of the conductive particles prepared in the process I to the solution, and seal the mixture and heat in an autoclave at 120° C. for 30 minutes, cool to room temperature, and then wash the surface-treated conductive particles with DI water and dry in a conventional oven for 12 hours.

### (Example 13) Surface Treatment of NiSO₄

Add 20 g of stearic acid and 50 g of DI water to 20 g of NiSO₄, and stir the mixture for 30 minutes while adding 50 mL of ethanol. Then, add 20 g of the conductive particles prepared in the process I to the solution, and seal the mixture and heat in an autoclave at 120° C. for 1 hour, cool to room temperature, and then wash the surface-treated conductive particles with DI water and dry in a conventional oven for 12 hours.

### (Example 14) Surface Treatment of FeO

Add 20 g of stearic acid and 50 g of DI water to 20 g of FeO, and stir the mixture for 30 minutes while adding 50 mL of ethanol. Then, add 20 g of the conductive particles prepared in the process I to the solution, and seal the mixture and heat in an autoclave at 120° C. for 1 hour, cool to room temperature, and then wash the surface-treated conductive particles with DI water and dry in a conventional oven for 12 hours.

### (Example 15) Surface Treatment of Pd(NO₃)₂

Add 20 g of stearic acid and 50 g of DI water to 20 g of Pd(NO₃)₂, and stir the mixture for 30 minutes while adding 50 mL of ethanol. Then, add 20 g of the conductive particles prepared in the process I to the solution, and seal the mixture and heat in an autoclave at 120° C. for 30 minutes, cool to room temperature, and then wash the surface-treated conductive particles with DI water and dry in a conventional oven for 12 hours.

### (Example 16) Surface Treatment of AgNO₃

Add 20 g of stearic acid and 50 g of DI water to 20 g of AgNO₃, and stir the mixture for 30 minutes while adding 50 mL of ethanol. Then, add 20 g of the conductive particles prepared in the process I to the solution, and seal the mixture and heat in an autoclave at 120° C. for 6 hours, cool to room temperature, and then wash the surface-treated conductive particles with DI water and dry in a conventional oven for 12 hours.

### (Example 17) Surface Treatment of Zn(NO₃)₂

Add 20 g of stearic acid and 50 g of DI water to 20 g of Zn(NO₃)₂, and stir the mixture for 30 minutes while adding 50 mL of ethanol. Then, add 20 g of the conductive particles prepared in the process I to the solution, and seal the mixture and heat in an autoclave at 120° C. for 6 hours, cool to room temperature, and then wash the surface-treated conductive particles with DI water and dry in a conventional oven for 12 hours.

### (Example 18) Surface Treatment of Fe(NO₃)₃

Add 20 g of stearic acid and 50 g of DI water to 20 g of Fe(NO₃)₃, and stir the mixture for 30 minutes while adding 50 mL of ethanol. Then, add 20 g of the conductive particles prepared in the process I to the solution, and seal the mixture and heat in an autoclave at 120° C. for 6 hours, cool to room temperature, and then wash the surface-treated conductive particles with DI water and dry in a conventional oven for 12 hours.

### (Example 19) Surface Treatment of Fe₂(SO₄)₃

Add 20 g of stearic acid and 50 g of DI water to 20 g of Fe₂(SO₄)₃, and stir the mixture for 30 minutes while adding 50 mL of ethanol. Then, add 20 g of the conductive particles prepared in the process I to the solution, and seal the mixture and heat in an autoclave at 120° C. for 6 hours, cool to room temperature, and then wash the surface-treated conductive particles with DI water and dry in a conventional oven for 12 hours.

### (Comparative Example 1) Surface Treatment of Metal Oxide Layer not Performed

Conductive particles prepared in the process I, which were not subjected to surface treatment with a separate metal oxide layer, were used.

### (Comparative Example 2) Surface Treatment of Ni(NO₃)₂

Add 20 g of stearic acid and 50 g of DI water to 20 g of Ni(NO₃)₂·6H₂O, and stir the mixture for 30 minutes while adding 50 mL of ethanol. Then, add 20 g of the conductive particles prepared in the process I to the solution, and seal the mixture and heat in an autoclave at 120° C. for 24 hours, cool to room temperature, and then wash the surface-treated conductive particles with DI water and dry in a conventional oven for 12 hours.

### II. Measurement of Powder Resistance

For the conductive particles of Examples 1 to 19 and Comparative Examples 1 and 2, a powder resistance device was used to measure from 200 kgf to 2000 kgf, and the value at 1400 kgf was indicated among the measured values. In addition, the rate of increase in powder resistance after the formation of the metal oxide layer was measured for the conductive particles of Comparative Example 2 and Examples 1 to 19 based on the powder resistance of conductive particles of Comparative Example 1 by using the same method, and the measurement results are shown in Table 1.

### III. 85/85 Reliability Evaluation

The conductive particles of Examples 1 to 19 and Comparative Examples 1 and 2 were left for 72 hours under conditions of 85° C. and 85% RH (85/85), and then the powder resistance value was measured.

TABLE 1

| | | | | Powder | |
|---|---|---|---|---|---|
| | | | | Resistance | Powder |
| | | | | Increase | Resistance |
| | | Thickness | Powder | Rate After | After 85/85 |
| | Metal | of Surface | Resis- | Formation | Reliability |
| | Oxide | Treatment | tance | of Metal | Evaluation |
| | Layer | (nm) | (mΩ) | Oxide (%) | (mΩ) |
| Comparative | — | 0 | 1.2 | 0 | 625 |
| Example 1 | | | | | |
| Comparative | Ni(NO₃)₂ | 201.2 | 5.6 | 367 | 5.6 |
| Example 2 | | | | | |
| Example 1 | Ni(NO₃)₂ | 19.5 | 1.4 | 17 | 1.7 |
| Example 2 | Ni(NO₃)₂ | 38.2 | 1.8 | 50 | 2.1 |
| Example 3 | Ni(NO₃)₂ | 58.6 | 2.5 | 108 | 2.8 |
| Example 4 | Ni(NO₃)₂ | 81.2 | 3.2 | 167 | 3.9 |
| Example 5 | Ni(NO₃)₂ | 97.6 | 3.5 | 192 | 3.9 |
| Example 6 | Mn(NO₃)₂ | 48.2 | 2.9 | 142 | 3.2 |
| Example 7 | FeSO₄ | 53.6 | 2.6 | 117 | 3.1 |
| Example 8 | Cu(NO₃)₂ | 58.6 | 2.1 | 75 | 2.8 |
| Example 9 | ZnSO₄ | 43.6 | 2.4 | 100 | 2.6 |
| Example 10 | Ag₂O | 73.4 | 1.9 | 58 | 2.8 |
| Example 11 | PtO₂ | 20.3 | 1.5 | 25 | 1.8 |
| Example 12 | PdO | 15.2 | 1.8 | 50 | 2.0 |
| Example 13 | NiSO₄ | 69.3 | 2.1 | 75 | 3.4 |
| Example 14 | FeO | 54.1 | 2.7 | 125 | 3.3 |
| Example 15 | Pd(NO₃)₂ | 25.5 | 1.9 | 58 | 2.3 |
| Example 16 | AgNO₃ | 88.6 | 4.6 | 283 | 4.6 |
| Example 17 | Zn(NO₃)₂ | 86.3 | 4.3 | 258 | 4.4 |
| Example 18 | Fe(NO₃)₃ | 78.1 | 4.0 | 233 | 4.0 |
| Example 19 | Fe₂(SO₄)₃ | 91.3 | 3.8 | 216 | 3.8 |

In Table 1 above, when the results of Comparative Example 1 and Examples are compared, it can be confirmed that, in the case of Examples, the increase in the resistance of conductive particles including a metal oxide layer is smaller after the 85/85 reliability evaluation. This is considered to be because the metal oxide layer effectively protects the surface of the conductive layer, thereby improving the electrical stability of the conductive layer.

In addition, when the results of Comparative Example 2 and Examples are compared, it can be confirmed that when the thickness of the metal oxide layer is within 100 nm as in Examples, the powder resistance is low and the rate of increase in powder resistance after the formation of the metal oxide layer is also low. This is considered to be because when a metal oxide layer of an appropriate range is formed, the path through which the current passes becomes shorter and the interference due to the resistance characteristics of the oxide layer is relatively small.

In contrast, when the thickness of the metal oxide layer is excessively thick, the path through which the current must pass becomes longer, and the current flow is not obstructed by the resistance characteristics of the metal oxide layer, thereby increasing the powder resistance.

The present disclosure is not limited to the Examples above and may be prepared in various different forms.

The above description merely provides embodiments of the present disclosure, and those skilled in the art to which the present disclosure pertains will be able to make various modifications without departing from the essential characteristics of the present disclosure.

Accordingly, the Examples disclosed in this specification are intended to illustrate, and not limit, the present disclosure, and the spirit and scope of the present disclosure are not limited by these Examples. The scope of protection of the present disclosure should be interpreted by the claims, and all technologies within the scope equivalent thereto should be interpreted as being included within the scope of rights of the present disclosure.

1. A conductive particle comprising a core; a conductive layer formed on the core; and a metal oxide layer formed on the conductive layer.

2. The conductive particle of claim 1, wherein the metal of the metal oxide layer comprises Ni, Mn, Fe, Cu, Zn, Ag, Pd, Pt, or Au, or a combination thereof.

3. The conductive particle of claim 1, wherein the metal oxide layer comprises NiO, Ni₂O₃, MnO, Mn₂O₃, MnO₂, Mn₂O₇, FeO, Fe₂O₃, Fe₃O₄, Cu₂O, CuO, ZnO, Ag₂O, PdO, PtO₂, Au₂O₃, Ni(NO₃)₂, NiSO₄, Mn(NO₃)₂, MnSO₄, Fe(NO₃)₃, FeSO₄, Fe₂(SO₄)₃, Cu(NO₃)₂, CuSO₄, Zn(NO₃)₂, ZnSO₄, AgNO₃, Pd(NO₃)₂, PdSO₄, or Pt(SO₄)₂, or a combination thereof.

4. The conductive particle of claim 1, wherein the metal oxide layer has a thickness of 0.1 nm to 100 nm.

5. The conductive particle of claim 1, wherein the powder resistance increase rate after the metal oxide layer is formed is 300% or less.

6. The conductive particle of claim 1, wherein the core comprises resin particles or organic/inorganic hybrid particles.

7. The conductive particle of claim 1, wherein the conductive layer comprising Ni, comprises one or more selected from the group consisting of P, B, Cu, Au, Ag, W, Mo, Pd, Co, and Pt.

8. An anisotropic conductive material comprising the conductive particle of claim 1.

9. A connection structure comprising the anisotropic conductive material of claim 8.
